(19) United States
(12) Patent Application Publication
(10) Pub. No.: US 2026/0259377 A1
(43) Pub. Date: Sep. 3, 2026

(54) STAR COUPLER DEVICE

(71) Applicant: BE Epitaxy Semiconductor Technology Co., Ltd., Kaohsiung City (TW)

(72) Inventors: Yung-Jr HUNG, Kaohsiung City (TW); Chia-Hsuan CHIEN, Kaohsiung City (TW); Chih-Hsien CHEN, Kaohsiung City (TW); Hung-Ching CHUNG, Kaohsiung City (TW); Yi-Chen WU, Kaohsiung City (TW)

(21) Appl. No.: 19/550,229

(22) Filed: Feb. 25, 2026

Related U.S. Application Data
(60) Provisional application No. 63/765,759, filed on Mar. 2, 2025.

(51) Int. Cl. G02B 6/28; G02B 6/12; G02B 6/125

(52) U.S. Cl. CPC G02B 6/2813; G02B 6/12004; G02B 6/125; G02B 2006/12147

(57) ABSTRACT

A star coupler device includes a substrate and a coupler unit disposed on the substrate. The coupler unit includes plural first optical power splitters and plural second optical power splitters connected to the first optical power splitters, and the coupler unit includes M first inputs and N first outputs. While a first light including P first input wavelengths is input to the M first inputs, an output light power of each of the N first outputs is equal to 1/M of a total energy of P first input wavelengths of a first light input to the M first inputs, in which N and M are positive integers, and P is an integer.

This application claims priority to US Provisional Application Serial Number 63/765,759, filed March 02, 2025, which is herein incorporated by reference in its entirety.

### BACKGROUND

### Technical Field

The present disclosure relates to a coupler device, and more particularly to a star coupler device.

### Description of Related Art

Multi-wavelength light source, which provides more than two equally spaced wavelengths with uniform output power, is a promising technology to drive ever growing off-chip I/O bandwidth needed for data-intensive computing. The straight-forward way to generate a multi-wavelength light source is to connect outputs of multiple single-wavelength lasers to the inputs of a star coupler. At the star coupler outputs, optical signals with the same or different wavelengths incident from the inputs are equally split and then combined. This leads to multi-wavelength light sources.

Star coupler has been widely applied and implemented using fiber based discrete components. The star coupler can also be implemented on chip, in which the star coupler consists of two arrays of channel waveguides separated by a slab waveguide formed on a silicon substrate using silica/silicon technology. Such star coupler on chip technology has been in mass production, but their insertion loss varies from channel to channel, leading to non-uniform optical power at the outputs. This problem becomes more severe when the number of channel increases.

### SUMMARY

In one aspect of the present disclosure, a star coupler device is provided. By designing plural connection configurations between plural optical power splitters and plural optical crossover components, plural outputs of the star coupler device may be provided with uniform output light power. In other words, while a first light including P first input wavelengths is input to the M first inputs of the star coupler device, an output light power of each of the N first outputs is equal to 1/M of a total energy of the P first input wavelengths. Therefore, while the star coupler may be realized on a photonic integration platform, including but not limited to silicon, silicon nitride, silicon oxide nitride, III-V compound materials, and other materials that serve as the waveguide core materials, the star coupler device may be provided with uniform output light power.

A star coupler device is provided in accordance with an embodiment of method aspects of the present disclosure. The star coupler device includes a substrate and at least one first coupler unit. The at least one first coupler unit is disposed on the substrate, in which the at least one first coupler unit includes plural first optical power splitters and plural second optical power splitters which is connected to the first optical power splitters. In which, the at least one first coupler unit includes M first inputs and N first outputs. In which, the at least one first coupler unit is configured such that an output light power of each of the N first outputs is equal to 1/M of a total energy of P first input wavelengths of a first light input to the M first inputs, in which N and M are positive integers, and P is an integer.

According to some embodiments of the present disclosure, the at least one first coupler unit further include a first optical crossover component. The first optical crossover component is disposed on the substrate, in which the first optical crossover component is connected between the first optical power splitters and the second optical power splitters.

According to some embodiments of the present disclosure, the star coupler device further includes plural third optical power splitters and plural second optical crossover component. The third optical power splitters are connected to a first one of the at least one first coupler unit and a second one of the at least one first coupler unit, in which a Y direction is defined as direction extending from a bottom surface of the substrate to a top surface of the substrate, in which the first one of the at least one first coupler unit is adjacent to the second one of the at least one first coupler unit along the Y direction, and in which the third optical power splitters include N second outputs. The second optical crossover components are disposed on the substrate, in which the second optical crossover components are connected between the at least one first coupler unit and the third optical power splitters. In which, the first one of the at least one first coupler unit includes M second inputs, and the second one of the at least one first coupler unit includes M third inputs. In which, while the at least one first coupler unit is configured such that an output light power of each of the N second outputs is equal to 1/(2M) of a total energy of the P second input wavelengths of a second light input to the M second inputs and the M third inputs.

According to some embodiments of the present disclosure, the star coupler device further includes plural fourth optical power splitters. The fourth optical power splitters are connected between a third one of the at least one first coupler unit and a fourth one of the at least one first coupler unit, in which an X direction is defined as a direction extending from a first side surface of the substrate to a second side surface of the substrate, in which the X direction is orthogonal to the Y direction, and in which the third one of the at least one first coupler unit is adjacent to the fourth one of the at least one first coupler unit along the X direction. In which, the third one of the at least one first coupler unit includes plural fourth inputs and N third outputs, and in which the fourth one of the at least one first coupler unit includes plural fifth inputs and N fourth outputs. In which the fourth optical power splitters include M sixth inputs and plural fifth outputs, and in which the fifth outputs are connected to the fourth inputs and the fifth inputs to form at least one second coupler unit. In which, while the at least one first coupler unit is configured such that an output light power of each of the N third outputs and each of the N fourth outputs is equal to 1/M of a total energy of P third input wavelengths of a third light input to the M sixth inputs.

According to some embodiments of the present disclosure, an output direction of the N third outputs of the third one of the at least one first coupler unit is different from an output direction of the N fourth outputs of the fourth one of the at least one first coupler unit.

According to some embodiments of the present disclosure, an output direction of the N third outputs of the third one of the at least one first coupler unit is the same as an output direction of the N fourth outputs of the fourth one of the at least one first coupler unit.

According to some embodiments of the present disclosure, the star coupler device further includes plural fifth optical power splitters and plural third optical crossover components. The fifth optical power splitters are connected to a first one of the at least one second coupler unit and a second one of the at least one second coupler unit, in which the first one of the at least one second coupler unit is adjacent to the second one of the at least one first coupler unit along the Y direction. The third optical crossover components are disposed on the substrate, in which the third optical crossover components are connected between the first one of the at least one second coupler unit and the fifth optical power splitters, and between the second one of the at least one second coupler unit and the fifth optical power splitters. In which, the first one of the at least one second coupler unit includes M seventh inputs, and in which the second one of the at least one second coupler unit includes M eighth inputs. In which, the fifth optical power splitters include N fifth outputs, and in which the at least one second coupler unit is configured such that an output light power of each of the N sixth outputs is equal to 1/(2M) of a total energy of P fourth input wavelengths of a fourth light input to the M seventh inputs and M eighth inputs.

According to some embodiments of the present disclosure, the output directions of the N fifth outputs of the fifth optical power splitters are different.

According to some embodiments of the present disclosure, output directions of the N fifth outputs of the fifth optical power splitters are the same.

According to some embodiments of the present disclosure, the at least one first coupler unit further includes plural optical couplers. The optical couplers are disposed on the substrate, in which the optical couplers are connected to the M first inputs and the N first outputs of the at least one first coupler unit.

According to some embodiments of the present disclosure, N is the positive integer less than or equal to M.

According to some embodiments of the present disclosure, the first light is input to or output from the at least one first coupler unit through an optical waveguide component, and in which waveguide materials of the optical waveguide component include silicon, silicon nitride, silicon oxide, polymer materials, and III-V compound materials.

In one aspect of the present disclosure, a star coupler device is provided. The star coupler device includes a substrate and at least one first coupler unit. The at least one first coupler unit is disposed on the substrate, in which the at least one first coupler unit includes plural first optical power splitters and a second optical power splitter which is connected to the first optical power splitters. In which, the at least one first coupler unit includes M first inputs/outputs. In which, the at least one first coupler unit is configured such that an output light power of each of the M first inputs/outputs is equal to 1/M of a total energy of P first input wavelengths of a first light input to the M first inputs/outputs, in which M is a positive integer, and P is an integer.

According to some embodiments of the present disclosure, the star coupler device further includes plural third optical power splitters and plural first optical crossover components. The third optical power splitters are connected to M second inputs/outputs of a first one of the at least one first coupler unit and M third inputs/outputs of a second one of the at least one first coupler unit, and in which the third optical power splitters include 2M fourth inputs/outputs. The first optical crossover components are disposed on the substrate, in which the first optical crossover components are connected between the first one of the at least one first coupler unit and the third optical power splitters, and between the second one of the at least one first coupler unit and the third optical power splitters to form at least one second coupler unit. In which, the at least one second coupler unit is configured such that an output light power of each of the 2M fourth inputs/outputs is equal to 1/(2M) of a total energy of P second input wavelengths of a second light input to the 2M fourth inputs/outputs.

According to some embodiments of the present disclosure, the star coupler device further includes plural fourth optical power splitters. The fourth optical power splitters are connected between a third one and a fourth one of the at least one first coupler unit, and are connected to M fifth inputs/outputs of the third one of the at least one first coupler unit and M sixth inputs/outputs of the fourth one of the at least one first coupler unit. In which, the fourth optical power splitters include 2M seventh inputs/outputs. In which, the at least one first coupler unit is configured such that an output light power of each of the 2M seventh inputs/outputs is equal to 1/(2M) of a total energy of the P third input wavelengths of a third light input to the 2M seventh inputs/outputs.

According to some embodiments of the present disclosure, the star coupler device further includes plural fifth optical power splitters are connected between a first one of the at least one second coupler unit and a second one of the at least one second coupler unit, and are connected to M eighth inputs/outputs of the first one of the at least one second coupler unit and M ninth inputs/outputs of the second one of the at least one second coupler unit, in which an X direction is defined as a direction extending from a first side surface of the substrate to a second side surface of the substrate, and in which the first one of the at least one second coupler unit is adjacent to the second one of the at least one first coupler unit along the X direction. In which, the fifth optical power splitters include 2M tenth inputs/outputs. In which, the at least one second coupler unit is configured such that an output light power of each of the 2M tenth inputs/outputs is equal to 1/(2M) of a total energy of P fourth input wavelengths of a fourth light input to the 2M tenth inputs/outputs.

According to some embodiments of the present disclosure, the first light is input to or output from the at least one first coupler unit through an optical waveguide component, and in which waveguide materials of the optical waveguide component include silicon, silicon nitride, silicon oxide, polymer materials, and III-V compound materials.

### BRIEF DESCRIPTION OF THE DRAWINGS

For a more complete understanding of the embodiments and their advantages, refer to the following description in conjunction with the accompanying drawings, in which:

FIG. 1 is an example of a transmission star coupler device in accordance with some embodiments of the present disclosure.

FIG. 2 is another example of the transmission star coupler device in FIG. 1.

FIG. 3 is another example of the transmission star coupler device in FIG. 1.

FIG. 4 is an example of a transmission star coupler device in accordance with some embodiments of the present disclosure.

FIG. 5 is an example of a transmission star coupler device in accordance with some embodiments of the present disclosure.

FIG. 6 is another example of the transmission star coupler device in FIG. 5.

FIG. 7 is an example of a transmission star coupler device in accordance with some embodiments of the present disclosure.

FIG. 8 is an example of a reflective star coupler device in accordance with some embodiments of the present disclosure.

FIG. 9 is an example of a reflective star coupler device in accordance with some embodiments of the present disclosure.

FIG. 10 is an example of a reflective star coupler device in accordance with some embodiments of the present disclosure.

FIG. 11 is an example of a reflective star coupler device in accordance with some embodiments of the present disclosure.

### DETAILED DESCRIPTION

The embodiments of the present disclosure are discussed in detail below. However, it should be understood that the embodiments provide many applicable concepts that can be implemented in a wide variety of specific contexts. The embodiments discussed and disclosed are for illustrative purposes only and are not intended to limit the scope of the present disclosure. As used herein, the terms “first”, “second”, etc., do not specifically refer to order or sequence, but are intended only to distinguish components or operations that are described in the same technical terms.

Further, spatially relative terms, such as “beneath,” “below,” “lower,” “above,” “upper” and the like, may be used herein for ease of description to describe one element or feature’s relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

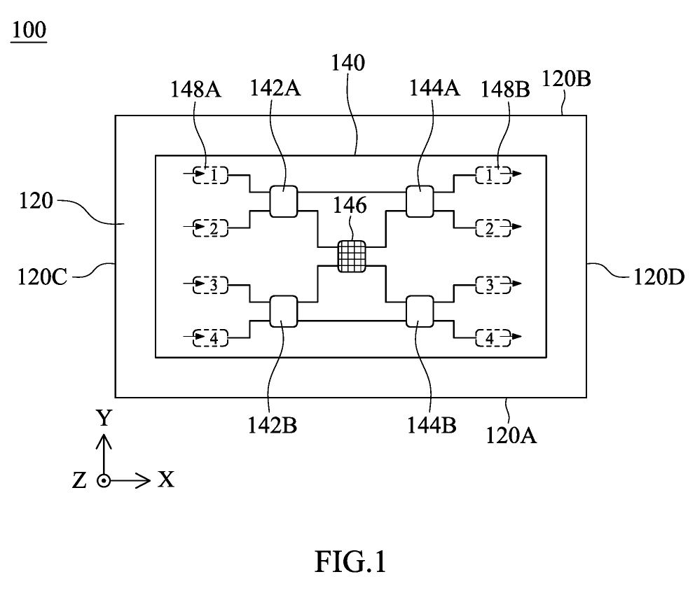

With reference to FIG. 1, FIG. 1 is an example of a transmission star coupler device 100 in accordance with some embodiments of the present disclosure. The transmission star coupler device 100 includes a substrate 120 and a coupler unit 140, in which the substrate 120 may be a semiconductor chip. The coupler unit 140 is disposed on the substrate 120, and the coupler unit 140 includes an optical power splitter 142A, an optical power splitter 142B, an optical power splitter 144A, an optical power splitter 144B, an optical crossover component 146, an optical coupler 148A, and an optical coupler 148B.

In some embodiments, the optical power splitter 142A and the optical power splitter 142B may be 3dB optical power splitters with two inputs and two outputs. For example, the optical power splitter 142A and the optical power splitter 142B may employ components such as directional coupler (DC), 2x2 multimode interference (MMI), or 2x2 adiabatic coupler, in which a direction Y is defined as a direction extending from a bottom surface 120A of the substrate 120 to a top surface 120B of the substrate 120, and the optical power splitter 142A is adjacent to the optical power splitter 142B along the direction Y.

In some embodiments, the optical power splitter 144A and the optical power splitter 144B may be the 3dB optical power splitters with two inputs and two outputs. For example, an upper input of the optical power splitter 144A is connected to an upper output of the optical power splitter 142A, and a lower input of the optical power splitter 144B is connected to a lower output of the optical power splitter 142B. The optical power splitter 144A and the optical power splitter 144B may employ components such as the directional coupler, the 2x2 multimode interference, or the 2x2 adiabatic coupler, in which a direction X is defined as a direction extending from a side surface 120C of the substrate 120 to a side surface 120D of the substrate 120. The optical power splitter 144A and the optical power splitter 144B are adjacent to the optical power splitter 142A and the optical power splitter 142B along the direction X, in which the optical power splitter 144A is adjacent to the optical power splitter 144B along the direction Y.

In some embodiments, the optical crossover component 146 is disposed on the substrate 120, and the optical crossover component 146 is connected between the optical power splitter 142A and the optical power splitter 144A, and between the optical power splitter 142B and the optical power splitter 144B, in which the optical crossover component 146 may be realized by a waveguide crossing (WGX) method. The optical crossover component 146 is utilized to transmit the input lights received at the inputs of the optical power splitter 142A to the inputs of the optical power splitter 144B, and the optical crossover component 146 is utilized to transmit the input lights received at the inputs of the optical power splitter 142B to the inputs of the optical power splitter 144A. For example, in the present embodiment, one terminal of the optical crossover component 146 is connected to a lower output of the optical power splitter 142A. The other terminal of the optical crossover component 146 is connected to an upper input of the optical power splitter 144B. The one terminal of the optical crossover component 146 is connected to an upper output of the optical power splitter 142B. The other terminal of the optical crossover component 146 is connected to a lower input of the optical power splitter 144A.

In some embodiments, the optical coupler 148A and the optical coupler 148B are disposed on the substrate 120, and the optical coupler 148A and the optical coupler 148B are respectively connected to the inputs of the optical power splitter 142A, the optical power splitter 142B, the optical power splitter 144A, and the optical power splitter 144B and the outputs of the optical power splitter 142A, the optical power splitter 142B, the optical power splitter 144A, and the optical power splitter 144B. Therefore, the optical power splitter 142A, the optical power splitter 142B, the optical power splitter 144A, the optical power splitter 144B, the optical crossover component 146, the optical coupler 148A, and the optical coupler 148B may form the coupler unit 140 with four inputs and four outputs.

It is worth mentioning that, the coupler unit 140 may be realized on the substrate 120 by an optical waveguide method. In other words, the input light may be input to the coupler unit 140 by an optical waveguide component (not shown) or the input light may be output from the coupler unit 140 by the optical waveguide component. Waveguide materials of the optical waveguide component include silicon, silicon nitride, silicon oxide, polymer materials, and III-V compound materials. Furthermore, while an input light including P input wavelengths is input to the four inputs of the coupler unit 140 by the optical waveguide component, an output light power of each of the four outputs is equal to 1/4 of a total energy of the P input wavelengths. The energy of each of the P input wavelengths may be the same or different, and P is an integer equal to or greater than zero.

For example, while the input light including the P input wavelengths is input to the optical coupler 148A to input to the upper input and the lower input of the optical power splitter 142A, the input light may be uniformly split (for example, the input light may be split at a ratio of one to one) into a second light and a third light by the optical power splitter 142A. The second light and the third light may be split to the upper output and the lower output of the optical power splitter 142A. Energy of the second light and the third light is equal to 1/2 of the total energy of the P input wavelengths, and the second light and the third light include the P input wavelengths. Subsequently, the second light is transmitted to the upper input of the optical power splitter 144A, and the third light is transmitted to the upper input of the optical power splitter 144B by the optical crossover component 146.

At the same time, the input light including the P input wavelengths is input to the optical coupler 148A to input to the upper input and the lower input of the optical power splitter 142B. The input light may be uniformly split (for example, the input light may be split at a ratio of one to one) into a fourth light and a fifth light by the optical power splitter 142B. The fourth light and the fifth light may be split to the upper output and the lower output of the optical power splitter 142B. Energy of the fourth light and the fifth light is equal to 1/2 of the total energy of the P input wavelengths, and the fourth light and the fifth light include the P input wavelengths. Subsequently, the fourth light is transmitted to the lower input of the optical power splitter 144A by the optical crossover component 146, and the fifth light is transmitted to the lower input of the optical power splitter 144B.

Subsequently, the second light and the fourth light may be uniformly split (for example, the second light and the fourth light may be split at a ratio of one to one) into a sixth light and a seventh light by the optical power splitter 144A. The sixth light and the seventh light may be split to the upper output and the lower output of the optical power splitter 144A to input to the optical coupler 148B, thus inputting to optical components and systems in subsequent applications. Energy of the sixth light and the seventh light is equal to 1/4 of the total energy of the P input wavelengths, and the sixth light and the seventh light include the P input wavelengths. The third light and the fifth light may be uniformly split (for example, the third light and the fifth light may be split at a ratio of one to one) into an eighth light and a ninth light by the optical power splitter 144B. The eighth light and the ninth light may be split to the upper output and the lower output of the optical power splitter 144B to input to the optical coupler 148B, thus inputting to the optical components and systems in subsequent applications. Energy of the eighth light and the ninth light is equal to 1/4 of the total energy of the P input wavelengths, and the eighth light and the ninth light include the P input wavelengths. Therefore, while the input light including the P input wavelengths is input to the four inputs of the coupler unit 140, each of the four outputs of the coupler unit 140 may output a first output light including the P input wavelengths, in which the first output light is formed by the eighth light and the ninth light, and an output light power of the first output light is equal to 1/4 of the total energy of the P input wavelengths of the input light.

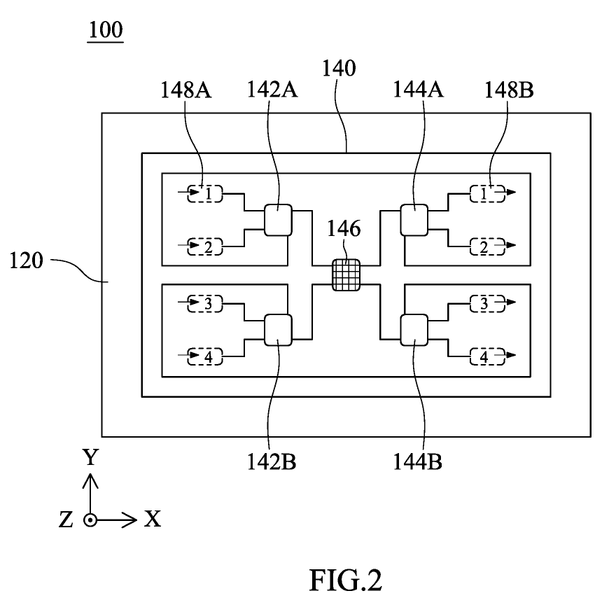

With reference to FIG. 2, FIG. 2 is another example of the transmission star coupler device 100 in FIG. 1. The transmission star coupler device 100 in FIG. 2 is similar to the transmission star coupler device 100 in FIG. 1. Differences between the transmission star coupler device 100 in FIG. 2 and the transmission star coupler device 100 in FIG. 1 are as follows. For example, in the present embodiment, the lower input of the optical power splitter 144A is connected to the lower output of the optical power splitter 142A, and the upper input of the optical power splitter 144B is connected to the upper output of the optical power splitter 142B. The one terminal of the optical crossover component 146 is connected to the upper output of the optical power splitter 142A, and the other terminal of the optical crossover component 146 is connected to the lower input of the optical power splitter 144B. The one terminal of the optical crossover component 146 is connected to the lower output of the optical power splitter 142B, and the other terminal of the optical crossover component 146 is connected to the upper input of the optical power splitter 144A.

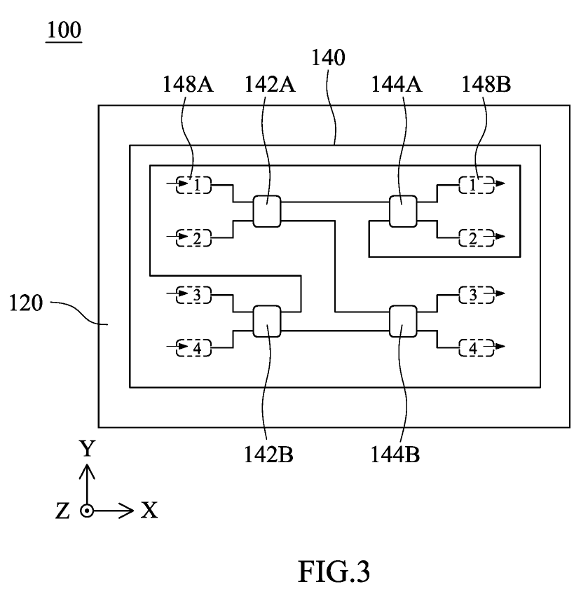

With reference to FIG. 3, FIG. 3 is another example of the transmission star coupler device 100 in FIG. 1. The transmission star coupler device 100 in FIG. 3 is similar to the transmission star coupler device 100 in FIG. 1. Differences between the transmission star coupler device 100 in FIG. 3 and the transmission star coupler device 100 in FIG. 1 are as follows. For example, in the present embodiment, the transmission star coupler device 100 in FIG. 3 does not include the optical crossover component 146. The upper input of the optical power splitter 144A is connected to the upper output of the optical power splitter 142A, and the lower input of the optical power splitter 144A is connected to the upper output of the optical power splitter 142B. The upper input of the optical power splitter 144B is connected to the lower output of the optical power splitter 142A, and the lower input of the optical power splitter 144B is connected to the lower output of the optical power splitter 142B.

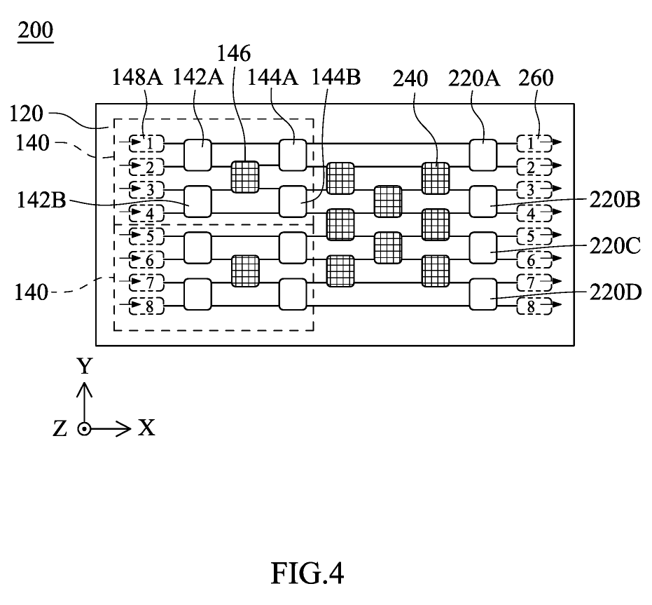

With reference to FIG. 4, FIG. 4 is an example of the transmission star coupler device 200 in accordance with some embodiments of the present disclosure. The transmission star coupler device 200 includes the substrate 120, two coupler units 140 adjacent to each other along the direction Y, four optical power splitters 220A to 220D, eight optical crossover components 240, and eight optical couplers 260. The coupler units 140 in the present embodiment do not include the optical coupler 148B.

In some embodiments, the optical power splitter 220A to the optical power splitter 220D are disposed on the substrate 120, and are connected to the coupler units 140. The optical power splitter 220A to the optical power splitter 220D may be the 3dB optical power splitters with two inputs and two outputs. For example, the optical power splitter 220A to the optical power splitter 220D may employ components such as the directional coupler, the 2x2 multimode interference, or the 2x2 adiabatic coupler, in which the optical power splitter 220A to the optical power splitter 220D are adjacent to each other along the direction Y.

In some embodiments, the optical crossover component 240 is disposed on the substrate 120, and the optical crossover component 240 is connected between the coupler units 140 and the optical power splitter 220A to the optical power splitter 220D, in which the optical crossover component 240 may be realized by the waveguide crossing method. The optical crossover component 240 is utilized to transmit the first output light output by the coupler units 140 to the lower input of the optical power splitter 220A, the upper input and lower input of the optical power splitter 220B, the upper input and lower input of the optical power splitter 220C, and the upper input of the optical power splitter 220D.

In some embodiments, the optical coupler 260 is disposed on the substrate 120, and connected to the outputs of the optical power splitter 220A to the optical power splitter 220D. Therefore, the coupler unit 140, the four optical power splitters 220A to 220D, the eight optical crossover components 240, and the eight optical couplers 260 may form the transmission star coupler device 200 with eight inputs and eight outputs.

It is worth mentioning that, the transmission star coupler device 200 is realized on the substrate 120 by the optical waveguide method. In other words, the input light may be input to the transmission star coupler device 200 by the optical waveguide component (not shown) or the input light may be output from the transmission star coupler device 200 by the optical waveguide component. Waveguide materials of the optical waveguide component include silicon, silicon nitride, silicon oxide, polymer materials, and III-V compound materials. Furthermore, while the input light including P input wavelengths is input to the eight inputs of the transmission star coupler device 200 by the optical waveguide component, an output light power of each of the eight outputs is equal to 1/8 of the total energy of the P input wavelengths of the input light. The energy of each of the P input wavelengths may be the same or different, and P is an integer equal to or greater than zero.

For example, while the input light including the P input wavelengths is input to the inputs of the coupler unit 140, each of the outputs of the coupler unit 140 may output the first output light including the P input wavelengths, in which the output light power of the first output light is equal to 1/4 of the total energy of the P input wavelengths of the input light.

Subsequently, the first output light is transmitted to the upper input of the optical power splitter 220A and the lower input of the optical power splitter 220D. The first output light is transmitted to the lower input of the optical power splitter 220A, the upper input and the lower input of the optical power splitter 220B, the upper input and the lower input of the optical power splitter 220C, and the upper input of the optical power splitter 220D by the optical crossover components 240.

Subsequently, the first output light may be uniformly split (for example, the first output light may be split at a ratio of one to one) into second output lights by the optical power splitter 220A to the optical power splitter 220D. The second output light may be respectively split to the upper outputs and the lower outputs of the optical power splitter 220A to the optical power splitter 220D to input to the optical coupler 260, thus inputting to optical components and systems in subsequent applications. Energy of the second output light is equal to 1/8 of the total energy of the P input wavelengths, and the second output light includes the P input wavelengths. Therefore, while the input light including the P input wavelengths is input to the eight inputs of the transmission star coupler device 200, each of the eight outputs of the transmission star coupler device 200 may output the second output light including the P input wavelengths, in which an output light power of the second output light is equal to 1/8 of the total energy of the P input wavelengths of the input light.

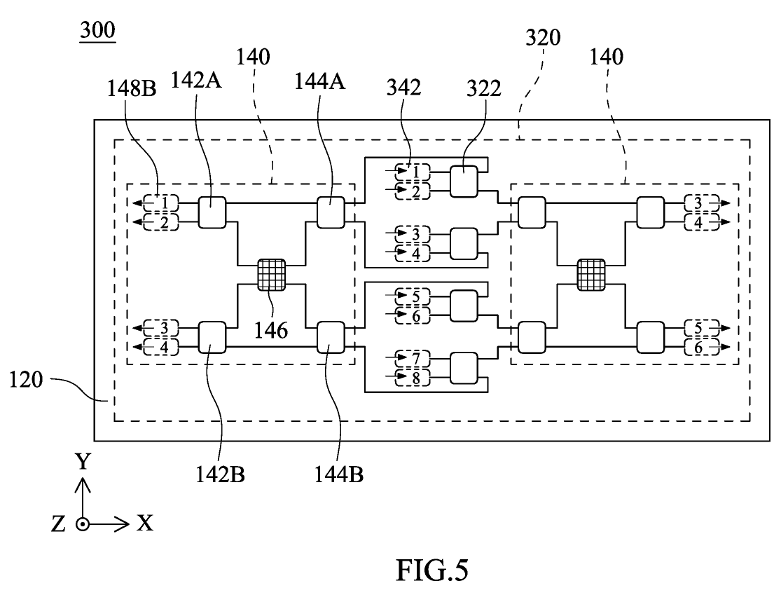

With reference to FIG. 5, FIG. 5 is an example of the transmission star coupler device 300 in accordance with some embodiments of the present disclosure. The transmission star coupler device 300 includes the substrate 120, two coupler units 140 adjacent to each other along the direction X, four optical power splitters 322, and eight optical couplers 342. The coupler units 140 in the present embodiment do not include the optical coupler 148A, and output directions of the outputs of the coupler units 140 are different. In other words, the output direction of the outputs of one of the coupler units 140 is the direction X, and the output direction of the outputs of the other coupler units 140 is a direction opposite to the direction X.

In some embodiments, the optical power splitters 322 may be the 3dB optical power splitters with two inputs and two outputs. For example, the optical power splitters 322 may employ components such as the directional coupler, the 2x2 multimode interference, or the 2x2 adiabatic coupler. The optical power splitters 322 are disposed on the substrate 120, the optical power splitters 322 are adjacent to each other along the direction Y, and the optical power splitters 322 are connected between the coupler units 140 to form a coupler unit 320 with eight inputs and eight outputs.

In some embodiments, the optical couplers 342 and the optical coupler 148B in the coupler units 140 may employ suitable optical components such as a grating coupler and an edge coupler having a mirror with a reflective angle of 45 degrees so as to allow the optical couplers 342 to be arbitrarily disposed on an arbitrary position of the substrate 120, not limiting to edges of the substrate 120. For example, the optical couplers 342 may be disposed on the substrate 120, and connected to the outputs of the optical power splitters 322. In other words, the optical couplers 342 may be disposed in the middle of the coupler unit 320 without damaging performances of the coupler unit 320. Therefore, design degrees of freedom of the coupler unit 320 may be improved.

It is worth mentioning that, the transmission star coupler device 300 is realized on the substrate 120 by the optical waveguide method. In other words, the input light may be input to the transmission star coupler device 300 by the optical waveguide component (not shown) or the input light may be output from the transmission star coupler device 300 by the optical waveguide component. Waveguide materials of the optical waveguide component include silicon, silicon nitride, silicon oxide, polymer materials, and III-V compound materials. Furthermore, while the input light including P input wavelengths is input to the eight inputs of the transmission star coupler device 300 by the optical waveguide component, an output light power of each of the eight outputs is equal to 1/8 of the total energy of the P input wavelengths of the input light. The energy of each of the P input wavelengths may be the same or different, and P is an integer equal to or greater than zero.

For example, while the input light including the P input wavelengths is input to the inputs of the optical power splitters 322, the input light may be uniformly split (for example, the input light may be split at a ratio of one to one) into a third output light by the optical power splitters 322. The third output light may be split to the inputs of the coupler unit 140. Energy of the third output light is equal to 1/2 of the total energy of the P input wavelengths, and the third output light includes the P input wavelengths.

Subsequently, the third output light may be split into a fourth output light by the coupler unit 140. Each of the outputs of the coupler unit 140 may output the fourth output light to the optical coupler 148B to input to optical components and systems in subsequent applications. The fourth output light includes the P input wavelengths, and an output light power of the fourth output light is equal to 1/8 of the total energy of the P input wavelengths of the input light. Therefore, while the input light including the P input wavelengths is input to the eight inputs of the transmission star coupler device 300, each of the eight outputs of the transmission star coupler device 300 may output the fourth output light including the P input wavelengths, in which an output light power of the fourth output light is equal to 1/8 of the total energy of the P input wavelengths of the input light.

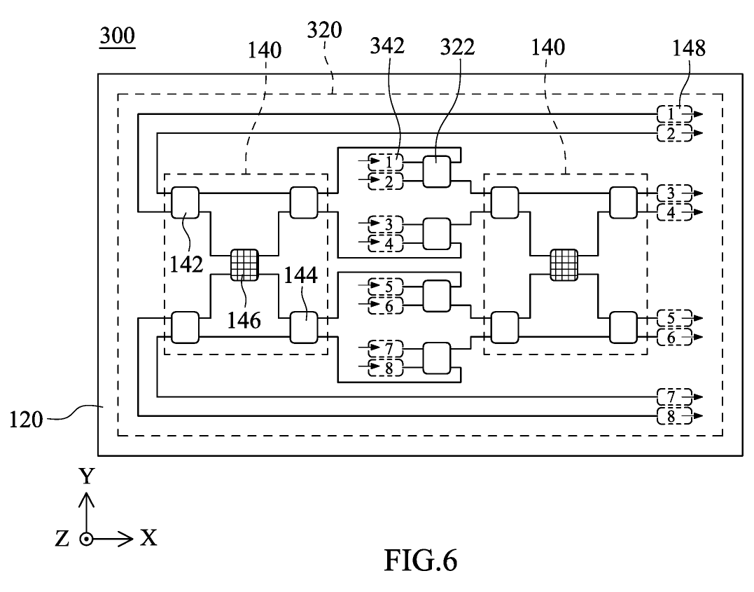

With reference to FIG. 6, FIG. 6 is another example of the transmission star coupler device 300 in FIG. 5. The transmission star coupler device 300 in FIG. 6 is similar to the transmission star coupler device 300 in FIG. 5. Differences between the transmission star coupler device 300 in FIG. 6 and the transmission star coupler device 300 in FIG. 5 are as follows. For example, in the present embodiment, the output directions of the outputs of the coupler units 140 are the same. In other words, the output direction of the outputs of one of the coupler units 140 and the output direction of the outputs of the other coupler units 140 are the direction X.

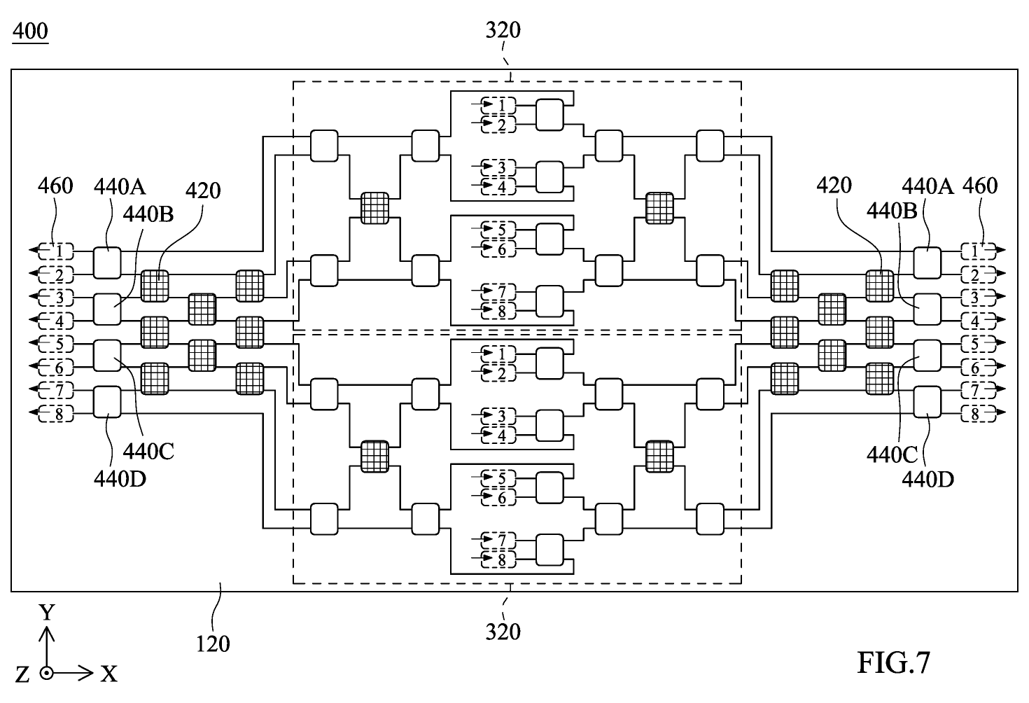

With reference to FIG. 7, FIG. 7 is an example of a transmission star coupler device 400 in accordance with some embodiments of the present disclosure. Taking the coupler unit 320 in FIG. 5 as an example, the coupler unit 320 in FIG. 6 may be obtained by analogy, thus not repeating herein. The transmission star coupler device 400 includes the substrate 120, two coupler units 320 adjacent to each other along the direction Y, eight optical power splitters 440A to 440D, a sixteen optical crossover component 420 and sixteen optical couplers 460. The coupler units 320 in the present embodiment do not include the optical coupler 148B.

In some embodiments, the optical crossover component 420 is disposed on the substrate 120, and the optical crossover component 420 is connected between the coupler units 320 and the optical power splitter 440A to the optical power splitter 440D, in which the optical crossover component 420 may be realized by the waveguide crossing method. The optical crossover component 420 is utilized to transmit the fourth output light output by the coupler units 320 to the lower input of the optical power splitter 440A, the upper input and lower input of the optical power splitter 440B, the upper input and lower input of the optical power splitter 440C, and the upper input of the optical power splitter 440D.

In some embodiments, the optical power splitter 440A to the optical power splitter 440D may be the 3dB optical power splitters with two inputs and two outputs. For example, the optical power splitter 440A to the optical power splitter 440D may employ components such as the directional coupler, the 2x2 multimode interference, or the 2x2 adiabatic coupler. The optical power splitter 440A to the optical power splitter 440D are disposed on the substrate 120, the optical power splitter 440A to the optical power splitter 440D are adjacent to each other along the direction Y, and the optical power splitter 440A to the optical power splitter 440D are connected to the coupler units 320.

In some embodiments, the optical coupler 460 is disposed on the substrate 120, and connected to the outputs of the optical power splitter 440A to the optical power splitter 440D. Therefore, the two coupler units 320, the eight optical power splitter 440A to the optical power splitter 440D, the sixteen optical crossover components 420, and the sixteen optical couplers 460 may form the transmission star coupler device 400 with sixteen inputs and sixteen outputs.

It is worth mentioning that, the transmission star coupler device 400 is realized on the substrate 120 by the optical waveguide method. In other words, the input light may be input to the transmission star coupler device 400 by the optical waveguide component (not shown) or the input light may be output from the transmission star coupler device 400 by the optical waveguide component. Waveguide materials of the optical waveguide component include silicon, silicon nitride, silicon oxide, polymer materials, and III-V compound materials. Furthermore, while the input light including P input wavelengths is input to the sixteen inputs of the transmission star coupler device 400 by the optical waveguide component, an output light power of each of the sixteen outputs is equal to 1/16 of the total energy of the P input wavelengths of the input light. The energy of each of the P input wavelengths may be the same or different, and P is an integer equal to or greater than zero.

For example, while the input light including the P input wavelengths is input to the inputs of the coupler units 320, each of the outputs of the coupler units 320 may output the fourth output light to the upper input of the optical power splitter 440A and the lower input of the optical power splitter 440D, and each of the outputs of the coupler units 320 may output the fourth output light to the lower input of the optical power splitter 440A, the upper input and the lower input of the optical power splitter 440B, the upper input and the lower input of the optical power splitter 440C, and the upper input of the optical power splitter 440D by the optical crossover components 420. The fourth output light includes the P input wavelengths, and the output light power of the fourth output light is equal to 1/8 of the total energy of the P input wavelengths of the input light.

Subsequently, the fourth output light may be uniformly split (for example, the fourth output light may be split at a ratio of one to one) into a fifth output light by the optical power splitter 440A to the optical power splitter 440D. The fifth output light may be respectively split to the optical couplers 460 to input to optical components and systems in subsequent applications. The fifth output light includes the P input wavelengths, and an output light power of the fifth output light is equal to 1/16 of the total energy of the P input wavelengths of the input light. Therefore, while the input light including the P input wavelengths is input to the sixteen inputs of the transmission star coupler device 400, each of the sixteen outputs of the transmission star coupler device 400 may output the fifth output light including the P input wavelengths, in which the output light power of the fifth output light is equal to 1/16 of the total energy of the P input wavelengths of the input light.

In addition, output directions of the outputs of the optical power splitter 440A to the optical power splitter 440D may be adjusted according to functional requirements, allowing output directions of the sixteen outputs of the transmission star coupler device 400 to be the same or different. For example, in the present embodiment, output directions of four of the optical power splitters 440A to 440D of the transmission star coupler device 400 are different from output directions of the other four optical power splitters 440A to 440D. In other words, output directions of eight of the sixteen outputs of the transmission star coupler device 400 are the direction X, and the output directions of the other eight outputs of the sixteen outputs of the transmission star coupler device 400 are directions opposite to the direction X. In other embodiments, the output directions of the eight optical power splitters 440A to 440D of the transmission star coupler device 400 are the same. In other words, the output directions of the sixteen outputs of the transmission star coupler device 400 are the direction X.

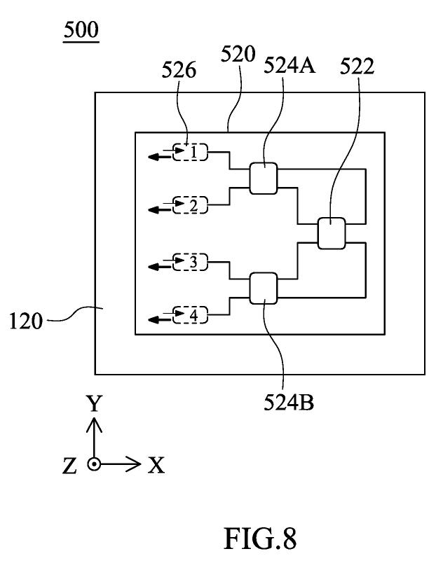

With reference to FIG. 8, FIG. 8 is an example of the reflective star coupler device 500 in accordance with some embodiments of the present disclosure. The reflective star coupler device 500 includes the substrate 120 and a coupler unit 520 disposed on the substrate 120. The coupler unit 520 includes an optical power splitter 522, an optical power splitter 524A, an optical power splitter 524B, and four optical couplers 526.

In some embodiments, the optical power splitter 522, the optical power splitter 524A, and the optical power splitter 524B may be the 3dB optical power splitters with two upper inputs/outputs and two lower inputs/outputs. For example, the optical power splitter 522, the optical power splitter 524A, and the optical power splitter 524B may employ components such as the directional coupler (DC), the 2x2 multimode interference (MMI), or the 2x2 adiabatic coupler, in which the optical power splitter 524A is adjacent to the optical power splitter 524B along the direction Y, and the optical power splitter 524A and the optical power splitter 524B are connected to the optical power splitter 522. For example, the upper inputs/outputs of the optical power splitter 522 are respectively upper inputs/outputs and lower inputs/outputs of the optical power splitter 524A, and the lower inputs/outputs of the optical power splitter 522 are respectively upper inputs/outputs and lower inputs/outputs of the optical power splitter 524B.

In some embodiments, the optical coupler 526 is disposed on the substrate 120, and the optical coupler 526 is respectively connected to the upper inputs/outputs and the lower inputs/outputs of the optical power splitter 524A and the upper inputs/outputs and the lower inputs/outputs of the optical power splitter 524B. Therefore, the optical power splitter 522, the optical power splitter 524A, the optical power splitter 524B, and the optical couplers 526 may form a coupler unit 520 with four inputs/outputs.

It is worth mentioning that, the coupler unit 520 is realized on the substrate 120 by the optical waveguide method. In other words, the input light may be input to the coupler unit 520 by the optical waveguide component (not shown) or the input light may be output from the coupler unit 520 by the optical waveguide component. Waveguide materials of the optical waveguide component include silicon, silicon nitride, silicon oxide, polymer materials, and III-V compound materials. Furthermore, while the input light including P input wavelengths is input to the four inputs/outputs of the coupler unit 520 by the optical waveguide component, an output light power of each of the four inputs/outputs is equal to 1/4 of the total energy of the P input wavelengths of the input light. The energy of each of the P input wavelengths may be the same or different, and P is an integer equal to or greater than zero.

For example, while the input light including the P input wavelengths is input to the optical coupler 526 to input to the optical power splitter 524A, the input light may be uniformly split (for example, the input light may be split at a ratio of one to one), and the optical power splitter 524A may output a tenth light and an eleventh light. Energy of the tenth light and the eleventh light is equal to 1/2 of the total energy of the P input wavelengths of the input light, and the tenth light and the eleventh light include the P input wavelengths.

At the same time, the input light including the P input wavelengths is input to the optical coupler 526 to input to the optical power splitter 524B. The input light may be uniformly split (for example, the input light may be split at a ratio of one to one) by the optical power splitter 524B, and the optical power splitter 524B may output a twelfth light and a thirteenth light. Energy of the twelfth light and the thirteenth light is equal to 1/2 of the total energy of the P input wavelengths of the input light, and the twelfth light and the thirteenth light include the P input wavelengths.

Subsequently, one of the tenth light and one of the eleventh light output by the optical power splitter 524A are exchanged to the optical power splitter 524B by the optical power splitter 522, and one of the twelfth light and one of the thirteenth light output by the optical power splitter 524B are exchanged to the optical power splitter 524A by the optical power splitter 522.

Subsequently, the other one of the tenth light and the eleventh light and the one of the twelfth light and the thirteenth light are uniformly split (for example, the other one of the tenth light and the eleventh light and the one of the twelfth light and the thirteenth light are split at a ratio of one to one) into a fourteenth light and a fifteenth light by the optical power splitter 524A. The fourteenth light and the fifteenth light may be split to the optical coupler 526 to input to optical components and systems in subsequent applications. Energy of the fourteenth light and the fifteenth light is equal to 1/4 of the total energy of the P input wavelengths of the input light, and the fourteenth light and the fifteenth light include the P input wavelengths.

The other one of the twelfth light and the thirteenth light and the one of the tenth light and the eleventh light are uniformly split (for example, the other one of the twelfth light and the thirteenth light and the one of the tenth light and the eleventh light are split at a ratio of one to one) into a sixteenth light and a seventeenth light by the optical power splitter 524B. The sixteenth light and the seventeenth light may be split to the optical coupler 526 to input to optical components and systems in subsequent applications. Energy of the sixteenth light and the seventeenth light is equal to 1/4 of the total energy of the P input wavelengths of the input light, and the sixteenth light and the seventeenth light include the P input wavelengths. Therefore, while the input light including the P input wavelengths is input to the four inputs/outputs of the coupler unit 520, each of the four inputs/outputs of the coupler unit 520 may output a fifth output light including the P input wavelengths, in which the fifth output light is formed by the fourteenth light, the fifteenth light, the sixteenth light, and the seventeenth light, and an output light power of the fifth output light is equal to 1/4 of the total energy of the P input wavelengths of the input light.

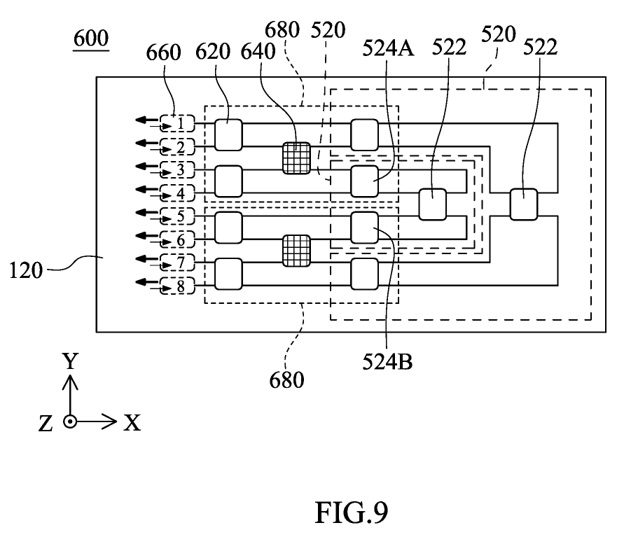

With reference to FIG. 9, FIG. 9 is an example of the reflective star coupler device 600 in accordance with some embodiments of the present disclosure. The reflective star coupler device 600 includes the substrate 120, two coupler units 520 adjacent to each other along the direction X, an optical power splitter 620, an optical crossover component 640, and eight optical couplers 660. The optical power splitter 524A in the coupler units 520, the optical power splitter 524B in the coupler units 520, the optical power splitter 620, and the optical crossover component 640 form a coupler unit 680, in which features of the coupler unit 680 are similar to the coupler unit 140, thus not repeating herein.

In some embodiments, the optical power splitter 620 is disposed on the substrate 120, and connected to the inputs/outputs of the coupler units 520. The optical power splitter 620 may be the 3dB optical power splitter with two inputs and two outputs. For example, the optical power splitter 620 may employ components such as the directional coupler, the 2x2 multimode interference, or the 2x2 adiabatic coupler.

In some embodiments, the optical crossover component 640 is disposed on the substrate 120, and the optical crossover component 640 is connected between the coupler unit 520 and the optical power splitter 620, in which the optical crossover component 640 may be realized by a waveguide crossing method.

In some embodiments, the optical coupler 660 is disposed on the substrate 120, and the optical coupler 660 is connected to the inputs/outputs of the coupler unit 680. Therefore, the substrate 120, the two coupler units 520 adjacent to each other along the direction X, the optical power splitter 620, the optical crossover component 640, and the eight optical couplers 660 may form the reflective star coupler device 600 with eight inputs/outputs.

It is worth mentioning that, the reflective star coupler device 600 may be realized on the substrate 120 by the optical waveguide method. In other words, the input light may be input to the reflective star coupler device 600 by the optical waveguide component (not shown) or the input light may be output from the reflective star coupler device 600 by the optical waveguide component. Waveguide materials of the optical waveguide component include silicon, silicon nitride, silicon oxide, polymer materials, and III-V compound materials. Furthermore, while the input light including P input wavelengths is input to the eight inputs/outputs of the reflective star coupler device 600 by the optical waveguide component, an output light power of each of the eight inputs/outputs is equal to 1/8 of a total energy of the P input wavelengths of the input light. The energy of each of the P input wavelengths may be the same or different, and P is an integer equal to or greater than zero.

For example, while the input light including the P input wavelengths is input to the four inputs/outputs of the upper coupler unit 680, each of the inputs/outputs of the upper coupler unit 680 may output a first upper output light including the P input wavelengths, in which an output light power of the first upper output light is equal to 1/4 of the total energy of the P input wavelengths of the input light. At the same time, the input light including the P input wavelengths is input to the four inputs/outputs of the lower coupler unit 680. Each of the inputs/outputs of the lower coupler unit 680 may output a first lower output light including the P input wavelengths, in which an output light power of the first lower output light is equal to 1/4 of the total energy of the P input wavelengths of the input light.

Subsequently, the first upper output light and the first lower output light are respectively exchanged to the upper coupler unit 140 or the lower coupler unit 140 by the optical power splitter 522 so as to allow both the upper coupler unit 680 and the lower coupler unit 680 to receive the first upper output light and the first lower output light.

Subsequently, the first upper output light and the first lower output light may be uniformly split into sixth output lights by the upper coupler unit 680 and the lower coupler unit 680. The sixth output light may be output to the optical coupler 660 to input to optical components and systems in subsequent applications. Energy of the sixth output light is equal to 1/8 of the total energy of the P input wavelengths of the input light, and the sixth output light includes the P input wavelengths. Therefore, while the input light including P input wavelengths is input to the eight inputs/outputs of the reflective star coupler device 600, each of the eight inputs/outputs of the reflective star coupler device 600 may output the sixth output light including the P input wavelengths. An output light power of the sixth output light is equal to 1/8 of a total energy of the P input wavelengths of the input light.

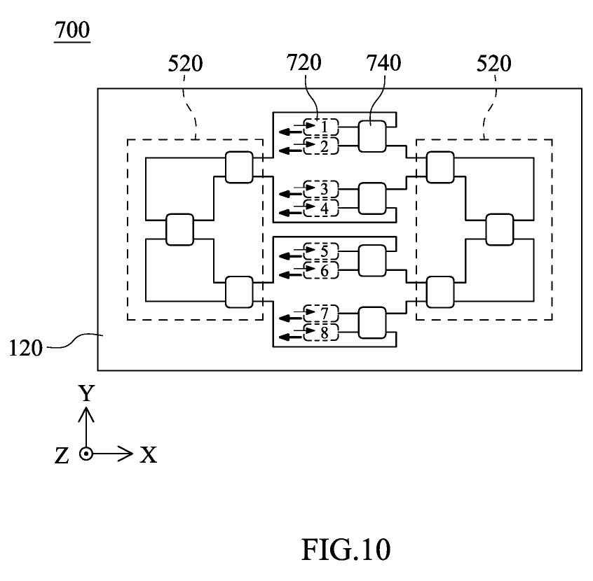

With reference to FIG. 10, FIG. 10 is an example of the reflective star coupler device 700 in accordance with some embodiments of the present disclosure. The reflective star coupler device 700 includes the substrate 120, the two coupler units 520 adjacent to each other along the direction X, eight optical couplers 720, and an optical power splitter 740, in which the coupler units 520 in the present embodiment do not include the optical coupler 526.

In some embodiments, the optical coupler 720 is disposed on the substrate 120, and the optical coupler 720 is connected to the inputs/outputs of the optical power splitter 740. The optical power splitter 740 is disposed on the substrate 120, and respectively connected to one of the coupler units 520 and the other coupler unit 520. The optical power splitter 740 may be the 3dB optical power splitters with two upper inputs/outputs and two lower inputs/outputs. For example, the optical power splitter 740 may employ components such as the directional coupler, the 2x2 multimode interference, or the 2x2 adiabatic coupler. Therefore, the substrate 120, the coupler unit 520 adjacent to each other along the direction X, the eight optical couplers 720, and the optical power splitter 740 may form the reflective star coupler device 700 with eight inputs/outputs.

It is worth mentioning that, the reflective star coupler device 700 may be realized on the substrate 120 by the optical waveguide method. In other words, the input light may be input to the reflective star coupler device 700 by the optical waveguide component (not shown) or the input light may be output from the reflective star coupler device 700 by the optical waveguide component. Waveguide materials of the optical waveguide component include silicon, silicon nitride, silicon oxide, polymer materials, and III-V compound materials. Furthermore, while the input light including P input wavelengths is input to the eight inputs/outputs of the reflective star coupler device 600 by the optical waveguide component, an output light power of each of the eight inputs/outputs is equal to 1/8 of a total energy of the P input wavelengths of the input light. The energy of each of the P input wavelengths may be the same or different, and P is an integer equal to or greater than zero.

For example, while the input light including the P input wavelengths is input to the optical coupler 720 to input to the input/output of the optical power splitter 740, the input light may be uniformly split (for example, the input light may be split at a ratio of one to one) into a seventh output light. The seventh output light may be respectively split to the inputs of the left coupler unit 520 and the inputs of the right coupler unit 520. Energy of the seventh output light is equal to 1/2 of the total energy of the P input wavelengths of the input light, and the seventh output light includes the P input wavelengths.

Subsequently, the seventh output light may be split into an eighth output light and a ninth output light by the left coupler unit 520 and the right coupler unit 520. Energy of the eighth output light and the ninth output light is equal to 1/4 of the total energy of the P input wavelengths of the input light, and the eighth output light and the ninth output light include the P input wavelengths.

The eighth output light and the ninth output light may be uniformly split (for example, the eighth output light and the ninth output light may be split at a ratio of one to one) into a tenth output light by the optical power splitter 740. The tenth output light may be output to the optical coupler 720 to input to optical components and systems in subsequent applications. Energy of the tenth output light is equal to 1/8 of the total energy of the P input wavelengths of the input light, and the tenth output light includes the P input wavelengths. Therefore, while the input light including P input wavelengths is input to the eight inputs/outputs of the reflective star coupler device 700, each of the eight inputs/outputs of the reflective star coupler device 700 may output the tenth output light including the P input wavelengths. An output light power of the tenth output light is equal to 1/8 of a total energy of the P input wavelengths of the input light.

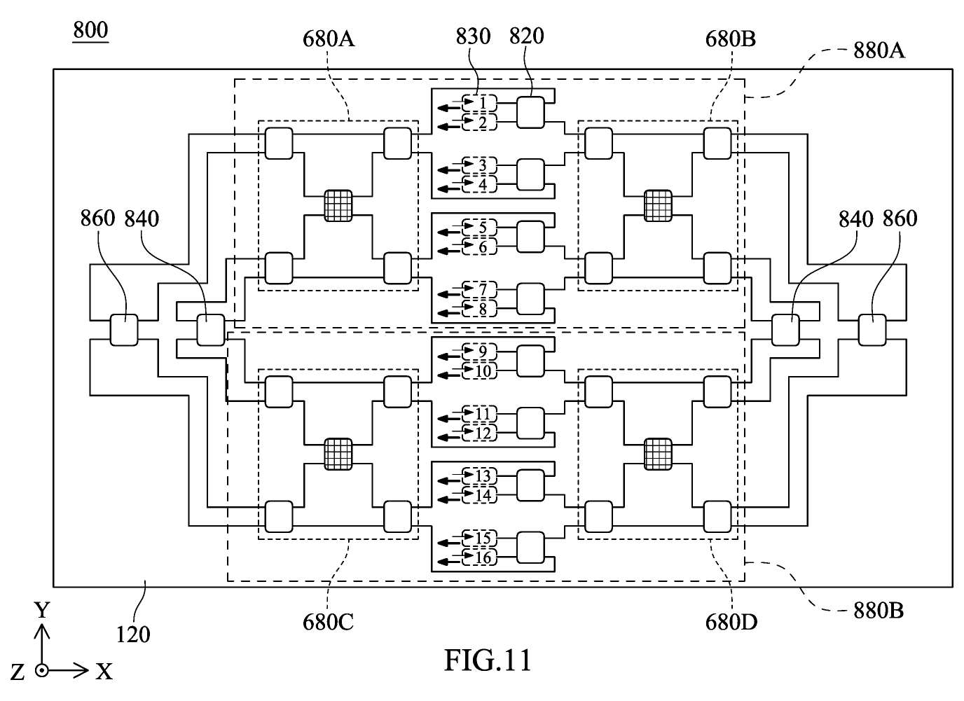

With reference to FIG. 11, FIG. 11 is an example of the reflective star coupler device 800 in accordance with some embodiments of the present disclosure. The reflective star coupler device 800 includes the substrate 120, an optical power splitter 820, sixteen optical couplers 830, four coupler units 680A to 680D, an optical power splitter 840, and an optical power splitter 860. The coupler unit 680A is adjacent to the coupler unit 680B along the direction X. The coupler unit 680A is adjacent to the coupler unit 680C along the direction Y. The coupler unit 680C is adjacent to the coupler unit 680D along the direction X. Features of the coupler unit 680A to the coupler unit 680D are similar to the coupler unit 680, thus not repeating herein.

In some embodiments, the optical power splitter 820 is disposed on the substrate 120, the optical power splitter 820 is respectively connected to the coupler unit 680A and the coupler unit 680B, and the optical power splitter 820 is respectively connected to the coupler unit 680C and the coupler unit 680D to form a coupler unit 880A and a coupler unit 880B which are adjacent to each other along the direction Y. The optical coupler 830 is connected to the inputs/outputs of the coupler unit 880A and the coupler unit 880B, and features of the coupler units 880A and the coupler unit 880B are similar to the coupler unit 320, thus not repeating herein. The optical power splitter 820 may be the 3dB optical power splitters with two inputs and two outputs. For example, the optical power splitter 820 may employ components such as the directional coupler, the 2x2 multimode interference, or the 2x2 adiabatic coupler.

In some embodiments, the optical power splitter 840 and the optical power splitter 860 are disposed on the substrate 120, and the optical power splitter 840 and the optical power splitter 860 are respectively connected to the inputs/outputs of the coupler unit 880A and the coupler unit 880B. The optical power splitter 840 and the optical power splitter 860 may be the 3dB optical power splitters with two upper inputs/outputs and two lower inputs/outputs. For example, the optical power splitter 840 and the optical power splitter 860 may employ components such as the directional coupler, the 2x2 multimode interference, or the 2x2 adiabatic coupler.

It is worth mentioning that, the reflective star coupler device 800 may be realized on the substrate 120 by the optical waveguide method. In other words, the input light may be input to the reflective star coupler device 600 by the optical waveguide component (not shown) or the input light may be output from the reflective star coupler device 800 by the optical waveguide component. Waveguide materials of the optical waveguide component include silicon, silicon nitride, silicon oxide, polymer materials, and III-V compound materials. Furthermore, while the input light including P input wavelengths is input to the sixteen inputs/outputs of the reflective star coupler device 800 by the optical waveguide component, an output light power of each of the sixteen inputs/outputs is equal to 1/16 of a total energy of the P input wavelengths of the input light. The energy of each of the P input wavelengths may be the same or different, and P is an integer equal to or greater than zero.

For example, while the input light including the P input wavelengths is input to the eight inputs/outputs of the coupler unit 880A, each of the eight inputs/outputs of the coupler unit 880A may output a second upper output light including the P input wavelengths. An output light power of the second upper output light is equal to 1/8 of a total energy of the P input wavelengths of the input light. At the same time, the input light including the P input wavelengths is input to the eight inputs/outputs of the coupler unit 880B. Each of the eight inputs/outputs of the coupler unit 880B may output a second lower output light including the P input wavelengths. An output light power of the second lower output light is equal to 1/8 of a total energy of the P input wavelengths of the input light.

Subsequently, the second upper output light and the second lower output light may be exchanged to the coupler unit 880A or the coupler unit 880B by the optical power splitter 840 or the optical power splitter 860 so as to allow the coupler unit 880A and the coupler unit 880B to receive the second upper output light and the second lower output light.

Subsequently, the second upper output light and the second lower output light may be split into an eleventh output light by the coupler unit 880A and the coupler unit 880B. The eleventh output light may be output to the optical coupler 830 to input to optical components and systems in subsequent applications. Energy of the eleventh output light is equal to 1/16 of the total energy of the P input wavelengths of the input light, and the eleventh output light includes the P input wavelengths.

It is worth mentioning that, the optical coupler 148A, the optical coupler 148B, the optical coupler 260, the optical coupler 342, the optical coupler 460, the optical coupler 526, the optical coupler 660, the optical coupler 720, and the optical coupler 830 may be selectively disposed according to the functional requirements. In other words, the optical coupler 148A, the optical coupler 148B, the optical coupler 260, the optical coupler 342, the optical coupler 460, the optical coupler 526, the optical coupler 660, the optical coupler 720, and the optical coupler 830 are not essential components. For example, in other embodiments, the transmission star coupler devices 100 to the transmission star coupler devices 400 and the reflective star coupler device 500 to the reflective star coupler device 800 may directly transmit the output light to the optical components and the systems in subsequent applications without the need to use the optical coupler 148A, the optical coupler 148B, the optical coupler 260, the optical coupler 342, the optical coupler 460, the optical coupler 526, the optical coupler 660, the optical coupler 720, and the optical coupler 830.

In summary, a star coupler device is provided. By designing plural connection configurations between plural optical power splitters and plural optical crossover components, plural outputs of the star coupler device may be provided with uniform output light power. In other words, while a first light including P first input wavelengths is input to the M first inputs of the star coupler device, an output light power of each of the N first outputs is equal to 1/M of a total energy of the P first input wavelengths. Therefore, while the star coupler may be realized on a photonic integration platform, including but not limited to silicon, silicon nitride, silicon oxide nitride, III-V compound materials, and other materials that serve as the waveguide core materials, the star coupler device may be provided with uniform output light power.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A star coupler device, comprising:
a substrate; and
at least one first coupler unit disposed on the substrate, wherein the at least one first coupler unit comprises:
a plurality of first optical power splitters; and
a plurality of second optical power splitters connected to the first optical power splitters;
wherein the at least one first coupler unit comprises M first inputs and N first outputs; and
wherein the at least one first coupler unit is configured such that an output light power of each of the N first outputs is equal to 1/M of a total energy of P first input wavelengths of a first light input to the M first inputs, wherein N and M are positive integers, and P is an integer.

2. The star coupler device of claim 1, wherein the at least one first coupler unit further comprises:
a first optical crossover component disposed on the substrate, wherein the first optical crossover component is connected between the first optical power splitters and the second optical power splitters.

3. The star coupler device of claim 2, further comprising:
a plurality of third optical power splitters connected to a first one of the at least one first coupler unit and a second one of the at least one first coupler unit, wherein a Y direction is defined as a direction extending from a bottom surface of the substrate to a top surface of the substrate, wherein the first one of the at least one first coupler unit is adjacent to the second one of the at least one first coupler unit along the Y direction, and wherein the third optical power splitters comprise N second outputs; and
a plurality of second optical crossover components disposed on the substrate, wherein the second optical crossover components are connected between the at least one first coupler unit and the third optical power splitters;
wherein the first one of the at least one first coupler unit comprises M second inputs, and the second one of the at least one first coupler unit comprises M third inputs; and
wherein the at least one first coupler unit is configured such that an output light power of each of the N second outputs is equal to 1/(2M) of a total energy of P second input wavelengths of a second light input to the M second inputs and the M third inputs.

4. The star coupler device of claim 3, further comprising:
a plurality of fourth optical power splitters connected between a third one of the at least one first coupler unit and a fourth one of the at least one first coupler unit, wherein an X direction is defined as a direction extending from a first side surface of the substrate to a second side surface of the substrate, wherein the X direction is orthogonal to the Y direction, and wherein the third one of the at least one first coupler unit is adjacent to the fourth one of the at least one first coupler unit along the X direction;
wherein the third one of the at least one first coupler unit comprises a plurality of fourth inputs and N third outputs, and wherein the fourth one of the at least one first coupler unit comprises a plurality of fifth inputs and N fourth outputs;
wherein the fourth optical power splitters comprise M sixth inputs and a plurality of fifth outputs, and wherein the fifth outputs are connected to the fourth inputs and the fifth inputs to form at least one second coupler unit;
wherein the at least one first coupler unit is configured such that an output light power of each of the N third outputs and each of the N fourth outputs is equal to 1/M of a total energy of P third input wavelengths of a third light input to the M sixth inputs.

5. The star coupler device of claim 4, wherein an output direction of the N third outputs of the third one of the at least one first coupler unit is different from an output direction of the N fourth outputs of the fourth one of the at least one first coupler unit.

6. The star coupler device of claim 4, wherein an output direction of the N third outputs of the third one of the at least one first coupler unit is the same as an output direction of the N fourth outputs of the fourth one of the at least one first coupler unit.

7. The star coupler device of claim 6, further comprising:
a plurality of fifth optical power splitters connected to a first one of the at least one second coupler unit and a second one of the at least one second coupler unit, wherein the first one of the at least one second coupler unit is adjacent to the second one of the at least one first coupler unit along the Y direction; and
a plurality of third optical crossover components disposed on the substrate, wherein the third optical crossover components are connected between the first one of the at least one second coupler unit and the fifth optical power splitters, and between the second one of the at least one second coupler unit and the fifth optical power splitters;
wherein the first one of the at least one second coupler unit comprises M seventh inputs, and wherein the second one of the at least one second coupler unit comprises M eighth inputs;
wherein the fifth optical power splitters comprise N fifth outputs, and wherein the at least one second coupler unit is configured such that an output light power of each of the N fifth outputs is equal to 1/(2M) of a total energy of P fourth input wavelengths of a fourth light input to the M seventh inputs and M eighth inputs.

8. The star coupler device of claim 7, wherein output directions of the N fifth outputs of the fifth optical power splitters are different.

9. The star coupler device of claim 7, wherein output directions of the N fifth outputs of the fifth optical power splitters are the same.

10. The star coupler device of claim 1, wherein the at least one first coupler unit further comprises:
a plurality of optical couplers disposed on the substrate, wherein the optical couplers are connected to the M first inputs and the N first outputs of the at least one first coupler unit.

11. The star coupler device of claim 1, wherein N is a positive integer less than or equal to M.

12. The star coupler device of claim 1, wherein the first light is input to or output from the at least one first coupler unit through an optical waveguide component, and wherein waveguide materials of the optical waveguide component comprise silicon, silicon nitride, silicon oxide, polymer materials, and III-V compound materials.

13. A star coupler device, comprising:
a substrate; and
at least one first coupler unit disposed on the substrate, wherein the at least one first coupler unit comprises:
a plurality of first optical power splitters; and
a second optical power splitter connected to the first optical power splitters;
wherein the at least one first coupler unit comprises M first inputs/outputs; and
wherein the at least one first coupler unit is configured such that an output light power of each of the M first inputs/outputs is equal to 1/M of a total energy of P first input wavelengths of a first light input to the M first inputs/outputs, wherein M is a positive integer, and P is an integer.

14. The star coupler device of claim 13, further comprising:
a plurality of third optical power splitters connected to M second inputs/outputs of a first one of the at least one first coupler unit and M third inputs/outputs of a second one of the at least one first coupler unit, and wherein the third optical power splitters comprise 2M fourth inputs/outputs;
a plurality of first optical crossover components disposed on the substrate, wherein the first optical crossover components are connected between the first one of the at least one first coupler unit and the third optical power splitters, and between the second one of the at least one first coupler unit and the third optical power splitters to form at least one second coupler unit; and
wherein the at least one second coupler unit is configured such that an output light power of each of the 2M fourth inputs/outputs is equal to 1/(2M)of a total energy of P second input wavelengths of a second light input to the 2M fourth inputs/outputs.

15. The star coupler device of claim 13, further comprising:
a plurality of fourth optical power splitters connected between a third one and a fourth one of the at least one first coupler unit, and connected to M fifth inputs/outputs of the third one of the at least one first coupler unit and M sixth inputs/outputs of the fourth one of the at least one first coupler unit; and
wherein the fourth optical power splitters comprise 2M seventh inputs/outputs;
wherein the at least one first coupler unit is configured such that an output light power of each of the 2M seventh inputs/outputs is equal to 1/(2M) of a total energy of P third input wavelengths of a third light input to the 2M seventh inputs/outputs.

16. The star coupler device of claim 14, further comprising:
a plurality of fifth optical power splitters connected between a first one of the at least one second coupler unit and a second one of the at least one second coupler unit, and connected to M eighth inputs/outputs of the first one of the at least one second coupler unit and M ninth inputs/outputs of the second one of the at least one second coupler unit, wherein an X direction is defined as a direction extending from a first side surface of the substrate to a second side surface of the substrate, and wherein the first one of the at least one second coupler unit is adjacent to the second one of the at least one first coupler unit along the X direction; and
wherein the fifth optical power splitters comprise 2M tenth inputs/outputs;
wherein the at least one second coupler unit is configured such that an output light power of each of the 2M tenth inputs/outputs is equal to 1/(2M) of a total energy of P fourth input wavelengths of a fourth light input to the 2M tenth inputs/outputs.

17. The star coupler device of claim 13, wherein the first light is input to or output from the at least one first coupler unit through an optical waveguide component, and wherein waveguide materials of the optical waveguide component comprise silicon, silicon nitride, silicon oxide, polymer materials, and III-V compound materials.
